(19) United States
(12) Patent Application Publication
(10) Pub. No.: US 2026/0348197 A1
(43) Pub. Date: Nov. 5, 2026

(54) LOCK WITH ADJUSTABLE LOCKING DIRECTION STRUCTURE

(71) Applicant: REAL LOCKS & SECURITY CO., LTD., New Taipei City (TW)

(72) Inventor: Hsi-Hao HO, New Taipei City (TW)

(21) Appl. No.: 19/568,614

(22) Filed: Mar. 16, 2026

(30) Foreign Application Priority Data
May 2, 2025 (TW) 114116649

(51) Int. Cl. E05B 63/00; E05B 1/00; E05B 9/08; E05B 9/04

(52) U.S. Cl. CPC E05B 63/0056; E05B 1/0007; E05B 9/08; E05B 2009/046

(57) ABSTRACT

A lock with an adjustable locking direction includes a shell, a lock core set, a knob, a control plate, and a latch tongue. The shell includes a housing and a cover. The housing includes a lock cylinder. The lock cylinder includes a rotation space and a restricting plane. The lock core set includes a lock core and a rotating shaft. The lock core is rotatably received in the lock cylinder. The rotating shaft includes a latching section and a coupling section. The knob is detachably connected to the lock core. The control plate is rotatable with the rotating shaft. The control plate includes a first stop portion and a second stop portion. The latch tongue is detachably coupled to the coupling section.

### BACKGROUND OF THE DISCLOSURE

### Technical Field

The technical field relates to a lock structure, and particularly to a lock with an adjustable locking direction structure.

### Description of Related Art

In the prior art, various types of locking mechanisms are widely used in door locks, safes, mechanical devices, and other fields. These mechanisms typically function by means of the engagement between a lock tongue or a locking bolt and a lock seat to prevent unauthorized access. However, the locking direction is fixed and not adjustable in most locks, and users are unable to modify the direction of the locking operation according to actual installation requirements. Therefore, different lock configurations must be purchased for different installation positions (e.g., left-hand doors versus right-hand doors), which increases the inconvenience of use.

Moreover, although the prior art has proposed adjustable locking structures to accommodate different door opening directions, such designs are often structurally complex, difficult to assemble, or require specialized tools for adjustment, thereby reducing their practicality and widespread applicability. Additionally, during the process of changing the locking direction, certain designs may compromise structural stability or security performance, and there is a need for improvement.

Accordingly, it is an objective of this disclosure to provide a lock structure that has a simple construction, is easy to operate, and allows the locking direction to be changed as needed, thereby enhancing application flexibility and user convenience.

### SUMMARY OF THE DISCLOSURE

One objective of this disclosure is to provide a lock with an adjustable locking direction structure, which has the advantages of a simple structure, easy operation, and the capability of changing the locking direction as needed, thereby enhancing the flexibility and convenience of use.

This disclosure is a lock including a shell, a lock core set, a knob, a control plate, and a latch tongue. The shell includes a housing and a cover attached to the housing. The housing includes a lock cylinder. The lock cylinder includes a rotation space located at the end away from the cover and a restricting plane located on one side of the rotation space. The lock core set includes a lock core and a rotating shaft. The lock core is rotatably received in the lock cylinder. The rotating shaft passes through the lock core and includes a latching section and a coupling section located on the end protruding from the lock cylinder. The knob is coupled to the cover and is detachably connected to the lock core. The control plate is fixed to the latching section and rotatable with the rotating shaft. The control plate includes a first stop portion and a second stop portion located spacedly and arranged at an angle relative to each other. The latch tongue is detachably coupled to the coupling section and rotating with the rotating shaft. When the control plate is mounted to the latching section of the rotating shaft by the first stop portion abutting against the restricting plane, the second stop portion is rotatable within the rotational space in a first direction until the second stop portion abuts against the restricting plane; and when the control plate is mounted to the latching section of the rotating shaft by the second stop portion abutting against the restricting plane, the first stop portion is rotatable within the rotational space in a second direction until the first stop portion abuts against the restricting plane.

In one embodiment of this disclosure, the lock further includes an operation set, wherein a plurality of slots is defined on the cover, and the operation set is disposed in the cover with a portion thereof exposed from the slots.

In one embodiment of this disclosure, the knob includes a knob post and a lever connected to the knob post; a keyhole is defined on the knob post, and the knob post is detachably connected to the lock core.

In one embodiment of this disclosure, the latching section includes a rectangular block; a rectangular hole is defined on the control plate; and the control plate is positioned on the rotating shaft by the rectangular hole engaging with the rectangular block.

In one embodiment of this disclosure, the first stop portion and the second stop portion are configured as planar surfaces.

In one embodiment of this disclosure, the control plate includes a rotating portion located between the first stop portion and the second stop portion.

In one embodiment of this disclosure, the rotating portion includes an arcuate surface.

In one embodiment of this disclosure, the control plate is configured as a rhombic-shaped plate.

In one embodiment of this disclosure, the latch tongue includes a fixing section and a latching section, and the latching section is connected to the fixing section and protrudes from a side of the housing.

In one embodiment of this disclosure, the lock further includes a nut, wherein the coupling portion includes a plurality of threads, and the latch tongue is coupled to the rotating shaft by being threaded onto the threads via the nut.

In comparison with the related art, the lock of this disclosure includes a shell, a lock core set, a knob, a control plate, and a latch tongue. The control plate includes a first stop portion and a second stop portion located spacedly and arranged at an angle relative to each other. Additionally, the control plate is positionable on the rotating shaft either by having the first stop portion abut against the restricting plane or by having the second stop portion abut against the restricting plane. When the first stop portion abuts against the restricting plane, the second stop portion is rotated within the rotational space in a first direction until the second stop portion abuts against the restricting plane. Moreover, when the second stop portion abuts against the restricting plane, the first stop portion is rotated within the rotational space in a second direction. Accordingly, the lock structure of this disclosure enables switching of the latch direction by altering the orientation of the knob, control plate, and the lock tongue. The structure is simple and easy to operate, and the locking direction may be adjusted as needed, which has the advantages of improving application flexibility and convenience of use.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIGS. 1, and 2 depict perspective schematic views from two sides of the lock of this disclosure.

FIG. 3 depicts a sectional schematic view of the lock with an adjustable locking direction structure of this disclosure.

FIGS. 4, and 5 depict schematic views illustrating the use of the lock of this disclosure in a first rotation direction.

FIG. 6 depicts a sectional view illustrating the lock of this disclosure in a first rotation direction.

FIGS. 7, and 8 depict perspective exploded schematic views of the lock of this disclosure.

FIGS. 9, and 10 depict assembly schematic views of another embodiment of the lock of this disclosure.

FIGS. 11, and 12 depict perspective schematic views of another embodiment from two sides of the lock of this disclosure.

FIG. 13 depicts an operation schematic view of another embodiment of the lock of this disclosure.

FIG. 14 depicts a sectional view illustrating another embodiment of the lock of this disclosure in a second rotation direction.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

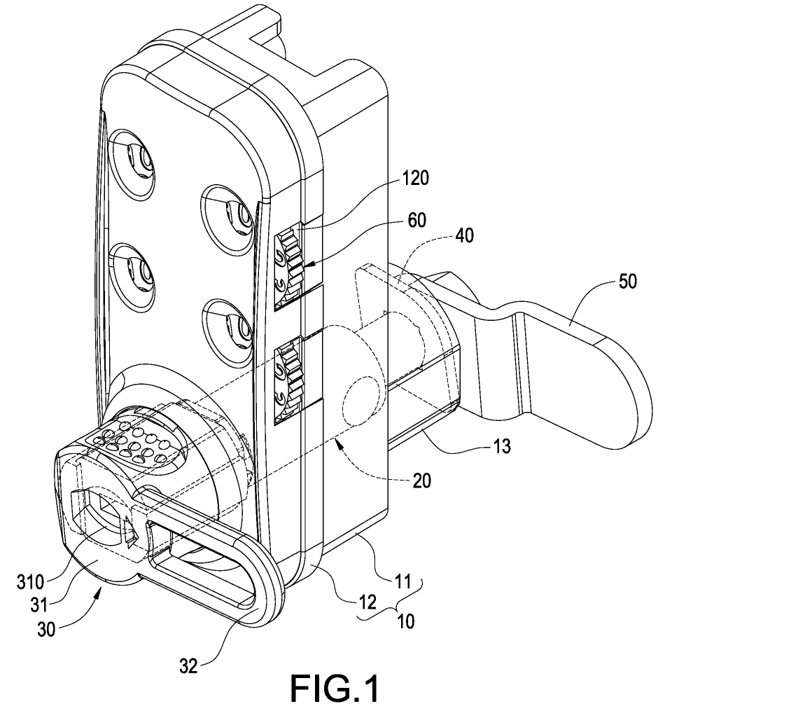

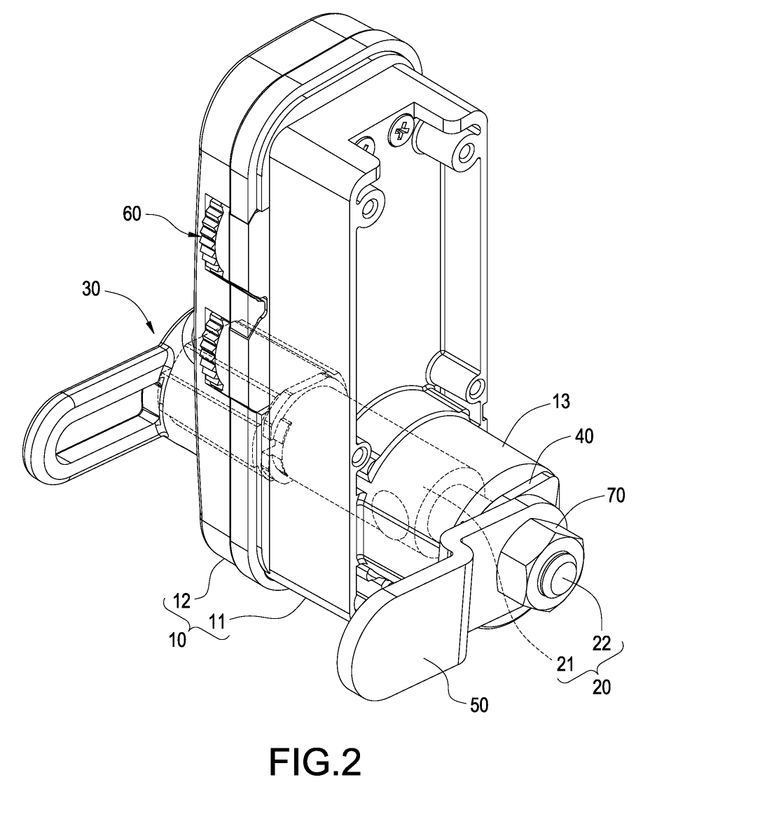

With reference to FIGS. 1, and 2 , which depict perspective schematic views from two sides of the lock of this disclosure, the lock 1 of this disclosure includes a shell 10, a lock core set 20, a knob 30, a control plate 40, and a latch tongue 50. The shell 10 includes a housing 11 and a cover 12 attached to the housing 11. The housing 11 includes a lock cylinder 13. The lock core set 20 includes a lock core 21 and a rotating shaft 22. The lock core 21 is rotatably received in the lock cylinder 13. The rotating shaft 22 passes through the lock core 21 and protrudes from the lock cylinder 13.

Moreover, the knob 30 is coupled to the cover 12 and is detachably connected to the lock core 21. In this embodiment, the knob 30 includes a knob post 31 and a lever 32 connected to the knob post 31. A keyhole 310 is defined on the knob post 31, and the knob post 31 is detachably connected to the lock core 21. The control plate 40 and the latch tongue 50 are combined at the point where the rotating shaft 22 protrudes from the locking cylinder 13, and they rotate along with the rotating shaft 22.

In this embodiment, the lock 1 further includes an operation set 60. Additionally, a plurality of slots 120 are defined on the cover 12. The operation set 60 is disposed in the cover 12 with a portion thereof exposed from the slots 120. Accordingly, a user may insert a key (not shown) into the keyhole 310 or unlock the lock 1 through the operation set 60, thereby driving the lock core set 20 to rotate.

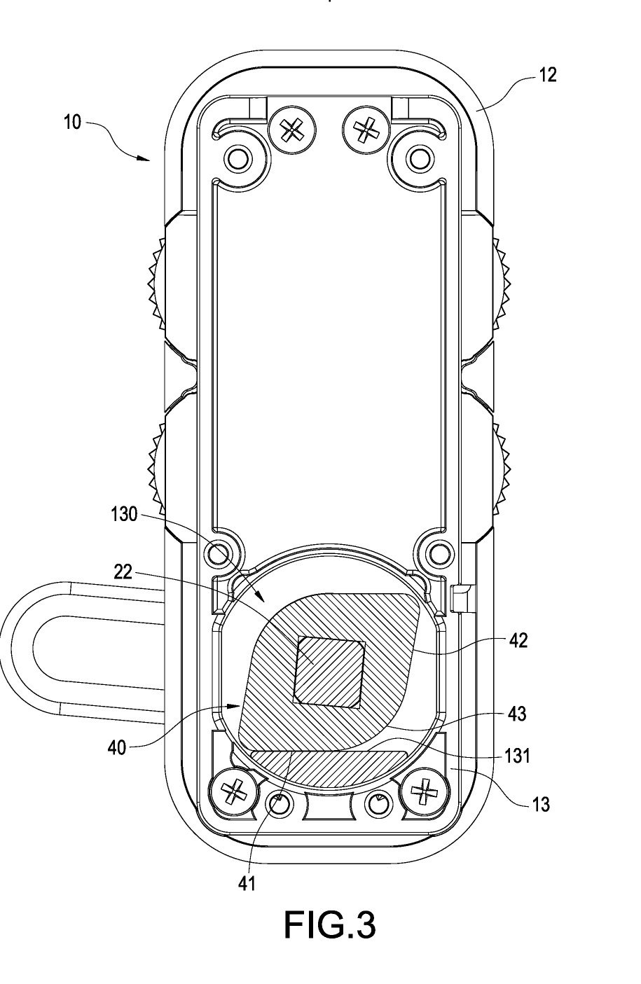

Please refer to FIG. 3, which depicts a sectional schematic view of the lock of this disclosure. In this embodiment, the control plate is fixed to the rotating shaft 22. Additionally, the lock cylinder 13 includes a rotation space 130 located on the end away from the cover 12 and a restricting plane 131 located on one side of the rotation space 130.

Specifically, the control plate 40 includes a first stop portion 41 and a second stop portion 42 located spacedly and arranged at an angle relative to each other. The control plate 40 is positionable on the rotating shaft 22 either by having the first stop portion 41 abut against the restricting plane 131 or by having the second stop portion 42 abut against the restricting plane 131. When the first stop portion 41 abuts the restricting plane 131, the second stop portion 42 rotates with the rotating shaft 22 within the rotational space 130 in one direction. Additionally, when the second stop portion 42 abuts the restricting plane 131, the first stop portion 41 rotates with the rotating shaft 22 within the rotational space 130 in another direction.

In this embodiment, the control plate 40 is configured as a rhombic-shaped plate to reduce the space required of rotation. The control plate 40 includes a rotation portion 43 disposed between the first stop portion 41 and the second stop portion 42. Furthermore, the first stop portion 41 and the second stop portion 42 are configured as planar surfaces to facilitate abutting against the restricting plane 131. The rotating portion 43 includes an arcuate surface to facilitate the rotation of the control plate 40.

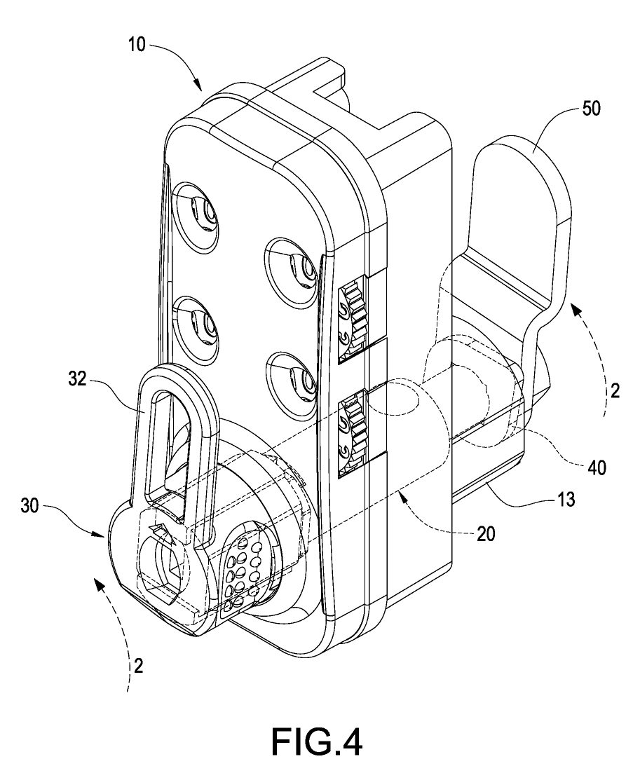

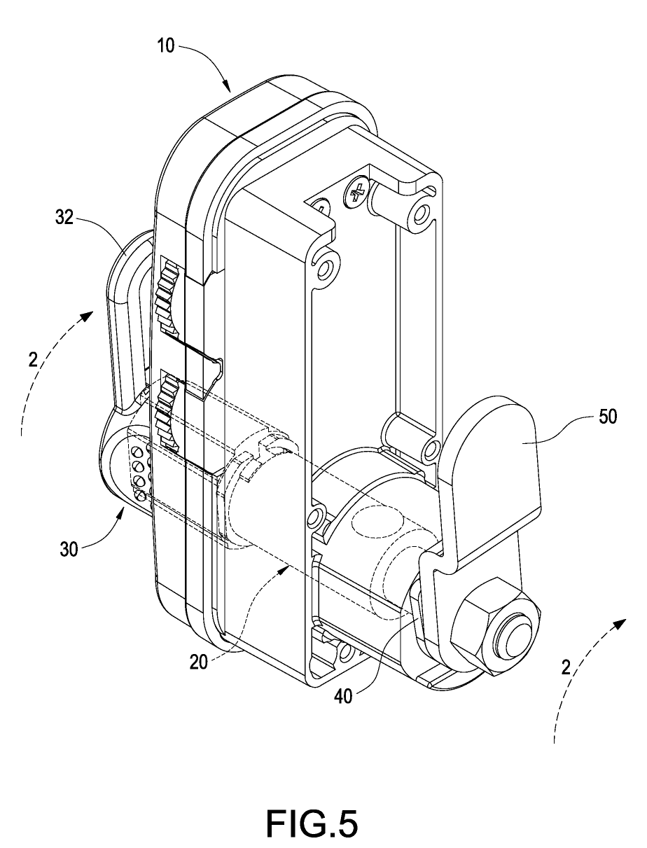

Please further refer to FIGS. 4, and 5, which depict schematic views illustrating the use of the lock of this disclosure in a first rotation direction. The lock 1 of this disclosure may switch the locking direction by changing the installation orientation of the knob 30, the control plate 40, and the latch tongue 50. In this embodiment, the lock 1 is configured to be installed on the right side of a cabinet door (not shown in the figures). The lock 1 is unlocked by rotating the knob 30 in a first direction 2 to drive the lock core set 20 to rotate in the first direction 2. As a result, the control plate 40 and the latch tongue 50 rotate along with the lock core set 20 in the first direction 2 to disengage the latch tongue 50 from the cabinet door.

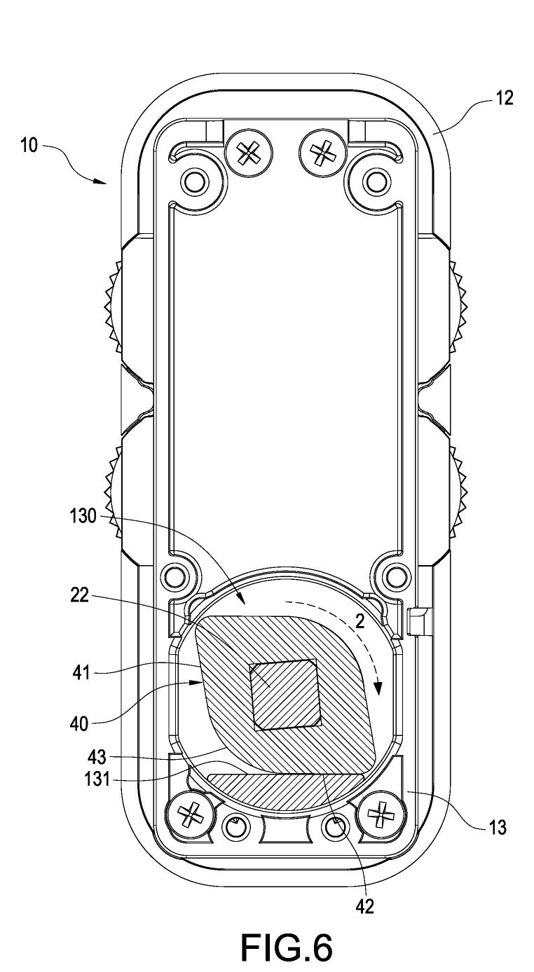

Referring also to FIG. 6, which depicts a sectional view illustrating the lock of this disclosure in a first rotation direction. In this embodiment, the lock 1 is positioned on the rotating shaft 22 (see FIG. 3) by the first stop portion 41 of the control plate 40 abutting against the restricting plane 131. When the lock 1 rotates in the first direction 2, the second stop portion 42 of the control plate 40 is capable of rotating within the rotation space 130 in the first direction 2 until the second stop portion 42 abuts against the restricting plane 131.

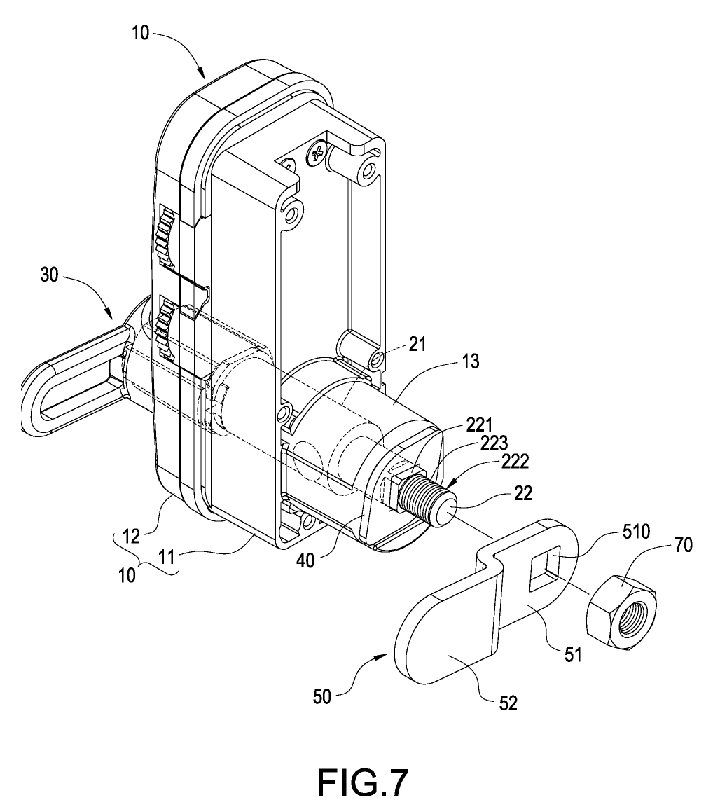

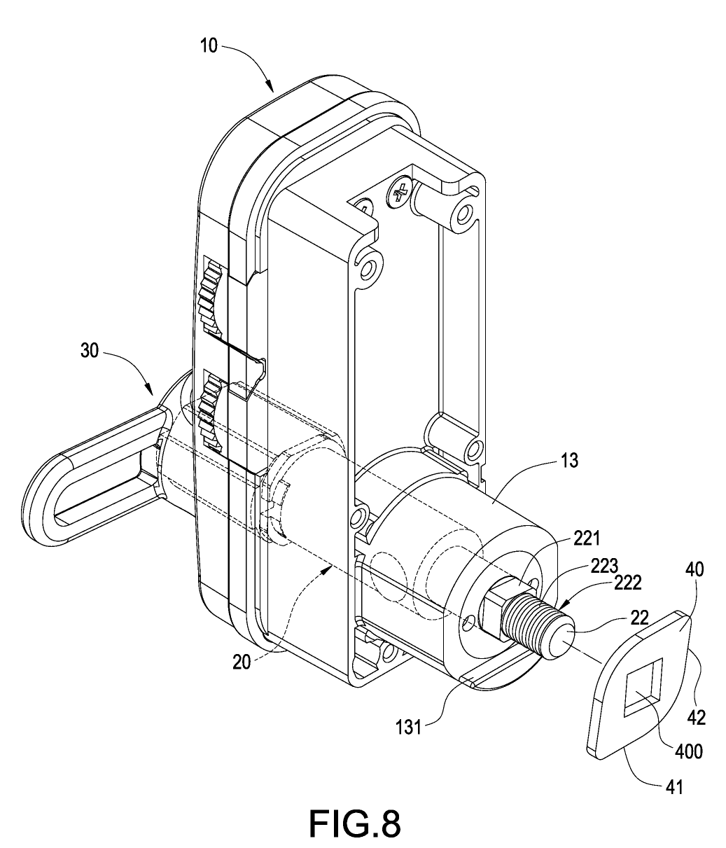

With reference to FIGS. 7, and 8, which depict perspective exploded schematic views of the lock of this disclosure, the lock 1 of this disclosure may switch the locking direction by changing the installation orientation of the knob 30, the control plate 40, and the latch tongue 50. To switch the locking direction of the latch tongue 50, the latch tongue 50 and the control plate 40 must first be detached from the rotating shaft 22. In this embodiment, the rotating shaft 22 inserts the lock core 21 and includes at a latching portion 221 and a coupling portion 222 at the end protruding from the lock cylinder 13. In this embodiment, the latching section 221 includes a rectangular block. A rectangular hole 400 is defined on the control plate 40. The control plate 40 is positioned on the rotating shaft 22 by the rectangular hole 400 engaging with the rectangular block 221 and rotates together with the rotating shaft 22.

Furthermore, the latch tongue 50 is detachably coupled to the coupling section 222 and rotates with the rotating shaft 22. The latch tongue 50 includes a fixing section 51 and a latching section 52. An opening 51 is disposed on the fixing section 51, and the fixing section 51 is mounted on the rotating shaft 22 via the opening 510. The latching section 52 is connected to the fixing section 51 and protrudes from one side of the housing 11. Moreover, the lock 1 further includes a nut 70. The coupling portion 222 includes a plurality of threads 223, and the latch tongue 50 is coupled to the rotating shaft 22 by being threaded onto the threads 223 via the nut 70.

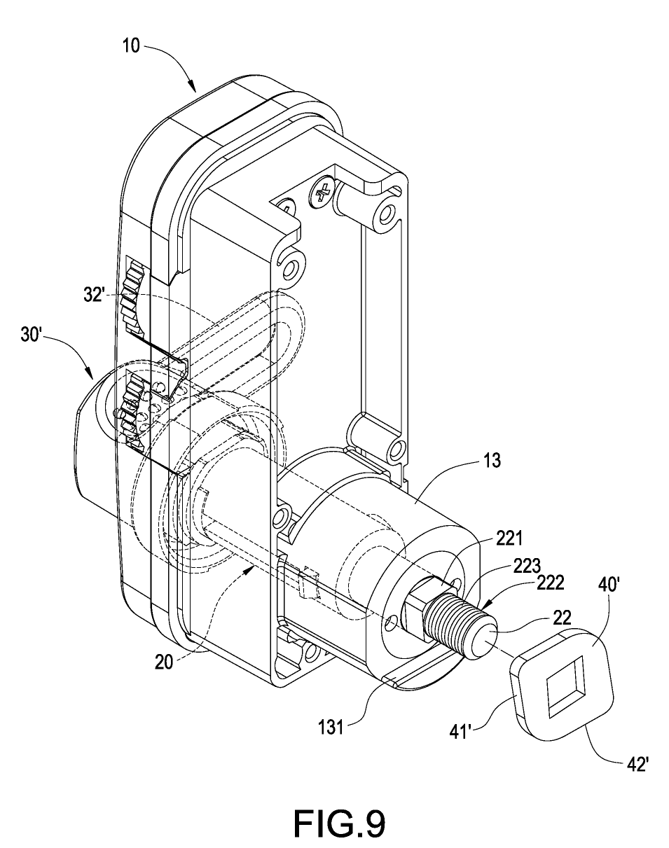

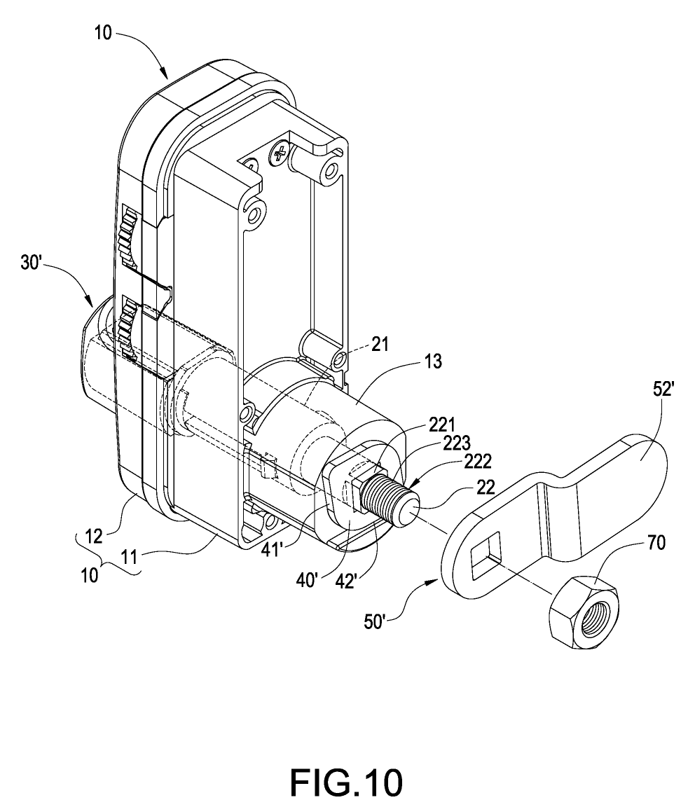

Please refer to FIGS. 9, and 10 , which depict assembly schematic views of another embodiment of the lock of this disclosure. This disclosure further provides a lock 1’ with an adjustable locking direction structure. As shown in FIG. 9, the knob 30' first rotates 180 degrees to the opposite side to rotate the lever 32' from the right side to the left side. Next, the control plate 40' is assembled onto the rotating shaft 22. In this embodiment, the installation angle of the control plate 40' is switched, the control plate 40' is positioned on the rotating shaft 22 with its second stop portion 42' abutting against the restricting plane 131. Subsequently, the latch tongue 50' is likewise rotated 180 degrees to the opposite side, and the latching section 52' is moved from the right side to the left side. Finally, the nut 70 is threaded to secure the control plate 40' and the latch tongue 50'.

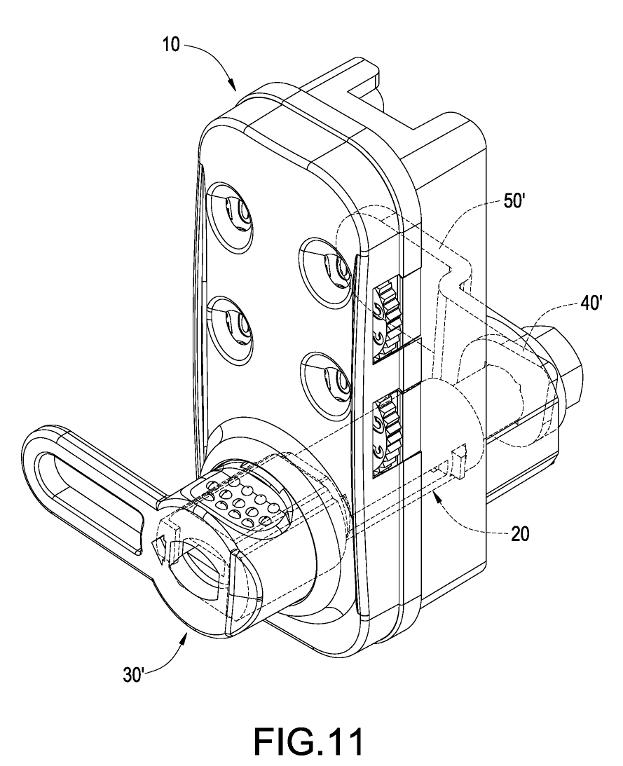

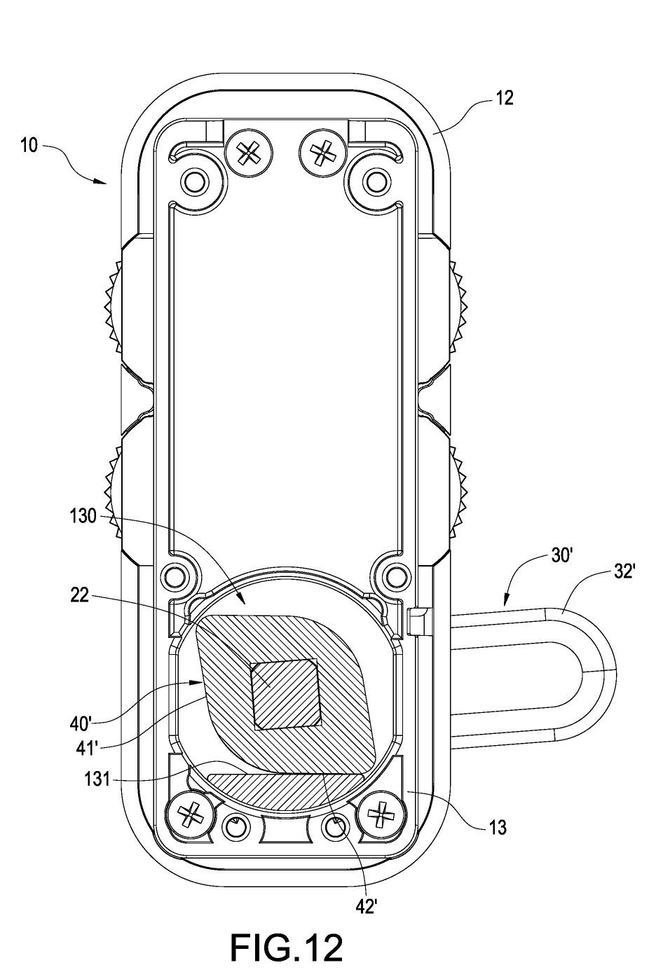

With reference to FIGS. 11, and 12, which depict perspective schematic views of another embodiment from two sides of the lock of this disclosure. As shown in FIG. 11, in this embodiment, the lock 1’ is configured to be installed on the left side of a cabinet door (not shown in the figures). Additionally, as shown in FIG. 12, when the second stop portion 42' abuts against the restricting plane 131’, the first stop portion 41' rotates along with the rotating shaft 22 within the rotational space 130 in the opposite direction.

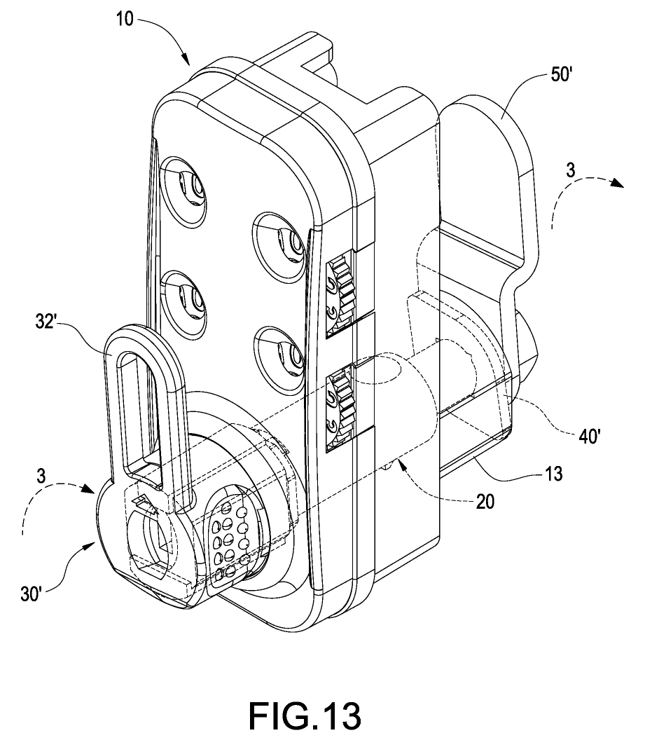

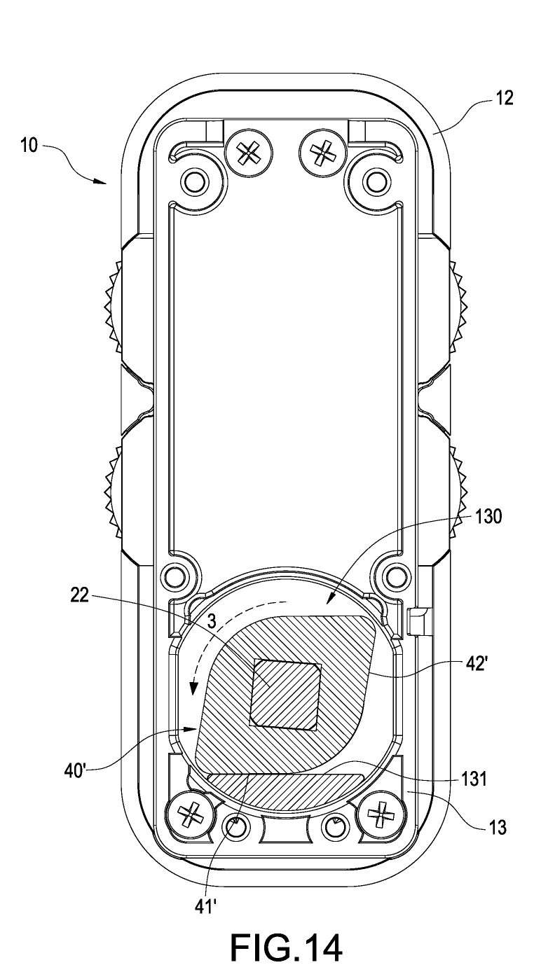

Please refer to FIGS. 13, and 14, which depicts an operation schematic view of another embodiment of the lock of this disclosure and a sectional view illustrating another embodiment of the lock of this disclosure in a second rotation direction. The lock 1’ is unlocked by rotating the knob 30’ in a second direction 3 to drive the knob 30’ to rotate in the second direction 3 to drive the lock core set 20 in the second rotation direction 3. As a result, the control plate 40’ and the latch tongue 50’ rotate along with the lock core set 20 in the second direction 3 to disengage the latch tongue 50’ from the cabinet door. Furthermore, as shown in FIG. 14, after the lock 1 is rotated in the first direction 2, the control plate 40' rotates along with the rotating shaft 22 until the first stop portion 41' abuts against the restricting plane 131 and stops.

While this disclosure has been described by means of specific embodiments, numerous modifications and variations may be made thereto by those skilled in the art without departing from the scope and spirit of this disclosure set forth in the claims.

What is claimed is:

1. A lock with an adjustable locking direction, the lock comprising:
a shell, comprising a housing and a cover attached to the housing, the housing comprising a lock cylinder, the lock cylinder comprising a rotation space located at an end away from the cover and a restricting plane located on one side of the rotation space;
a lock core set, comprising a lock core and a rotating shaft, wherein the lock core is rotatably received in the lock cylinder, the rotating shaft passes through the lock core and comprises a latching section and a coupling section located on an end protruding from the lock cylinder;
a knob, coupled to the cover and detachably connected to the lock core;
a control plate, fixed to the latching section and rotatable with the rotating shaft, the control plate comprising a first stop portion and a second stop portion located spacedly and arranged at an angle relative to each other; and
a latch tongue, detachably coupled to the coupling section and rotating with the rotating shaft;
wherein, when the control plate is mounted to the latching section of the rotating shaft by the first stop portion abutting against the restricting plane, the second stop portion is rotatable within the rotational space in a first direction until the second stop portion abuts against the restricting plane;
when the control plate is mounted to the latching section of the rotating shaft by the second stop portion abutting against the restricting plane, the first stop portion is rotatable within the rotational space in a second direction until the first stop portion abuts against the restricting plane.

2. The lock according to claim 1, further comprising an operation set, wherein a plurality of slots is defined on the cover, and the operation set is disposed in the cover with a portion thereof exposed from the slots.

3. The lock according to claim 1, wherein the knob comprises a knob post and a lever connected to the knob post; a keyhole is defined on the knob post, and the knob post is detachably connected to the lock core.

4. The lock according to claim 1, wherein the latching section comprises a rectangular block; a rectangular hole is defined on the control plate; and the control plate is positioned on the rotating shaft by the rectangular hole engaging with the rectangular block.

5. The lock according to claim 1, wherein the first stop portion and the second stop portion are configured as planar surfaces.

6. The lock according to claim 1, wherein the control plate comprises a rotating portion located between the first stop portion and the second stop portion.

7. The lock according to claim 6, wherein the rotating portion comprises an arcuate surface.

8. The lock according to claim 7, wherein the control plate is configured as a rhombic-shaped plate.

9. The lock according to claim 7, wherein the latch tongue comprises a fixing section and a latching section, and the latching section is connected to the fixing section and protrudes from a side of the housing.

10. The lock according to claim 1, further comprising a nut, wherein the coupling portion comprises a plurality of threads, and the latch tongue is coupled to the rotating shaft by being threaded onto the threads via the nut.
